(19) United States
(12) Patent Application Publication
(10) Pub. No.: US 2008/0286629 A1
(43) Pub. Date: Nov. 20, 2008

(54) CHEMICALLY CROSS LINKED IONOMER MEMBRANE

(75) Inventors: David Olmeijer, San Francisco, CA (US); Tara Arends, Mountain View, CA (US)

Correspondence Address: MORGAN, LEWIS & BOCKIUS, LLP, ONE MARKET SPEAR STREET TOWER, SAN FRANCISCO, CA, 94105, US

(73) Assignee: Polyfuel, Inc., Mountain View, CA (US)

(21) Appl. No.: 12/123,355

(22) Filed: May 19, 2008

Related U.S. Application Data
(60) Provisional application No. 60/938,984, filed on May 18, 2007.
(60) Provisional application No. 61/016,361, filed on Dec. 21, 2007.

(51) Int. Cl. H01M 8/10; C08J 5/22

(52) U.S. Cl. 429/33; 521/27

(57) ABSTRACT

The invention provides cross-linked polymer electrolyte membranes (PEM's), catalyst coated proton exchange membranes (CCM's) and membrane electrode assemblies (MEA's) that are useful in fuel cells and their application in electronic devices, power sources and vehicles.

### CROSS REFERENCE TO RELATED APPLICATIONS

The present application claims priority to U.S. Provisional Application Ser. No. 60/938,984, filed May 18, 2007 and to U.S. Provisional Application Ser. No. 61/016,361, filed Dec. 21, 2007, which are incorporated herein by reference.

### FIELD OF THE INVENTION

This invention relates to chemically cross-linked polymer electrolyte membranes that are useful in fuel cells.

### BACKGROUND OF THE INVENTION

Fuel cells are promising power sources for portable electronic devices, electric vehicles, and other applications due mainly to their non-polluting nature. Of various fuel cell systems, polymer electrolyte membrane based fuel cells such as direct methanol fuel cells (DMFCs) and hydrogen fuel cells have attracted significant interest because of their high power density and energy conversion efficiency. The “heart” of a polymer electrolyte membrane based fuel cell is the so called “membrane-electrode assembly” (MEA), which comprises a proton exchange membrane (PEM), catalyst disposed on the opposite surfaces of the PEM to form a catalyst coated membrane (CCM) and a pair of electrodes (i.e., an anode and a cathode) disposed to be in electrical contact with the catalyst layer.

The need for a good membrane for fuel cell operations requires balancing various properties of the membrane. Such properties included proton conductivity, fuel-resistance, chemical stability and fuel crossover, especially for high temperature applications, fast start up of DMFCs, and durability. In addition, it is important for the membrane to retain its dimensional stability over the fuel operational temperature range. If the membrane swells significantly, it will increase fuel crossover, resulting in degradation of cell performance. Dimensional changes of the membrane also put stress on the bonding of the catalyst membrane-electrode assembly (MEA). Often this results in delamination of the membrane from the catalyst and/or electrode after excessive swelling of the membrane. Therefore, it is necessary to maintain the dimensional stability of the membrane over a wide temperature range to minimize membrane swelling.

### SUMMARY OF THE INVENTION

The invention is directed to the cross-linking of ion conductive polymers containing sulfonic acid groups (sometimes referred to as precursor ion conducting polymers). Some or all of the sulfonate groups —SO₃M (where M is H or alkali metal cation) are converted to a cross linking group such as a sulfonyl halide —SO₂X (where X═F, Cl, Br, I) and/or a sulfinate salt —SO₂M to form an activated ion conducting polymer. The activated polymer is them combined with a chemically active reagent or a cross-linking agent to form a reactive polymer mixture which is then formed into a polymer electrolyte membrane under appropriate crosslinking conditions. All or a portion of the cross linking groups react with other cross linking groups or a cross linking agent, if present, to form a cross linked ion conductive polymer. Unreacted sulfonyl halide or sulfinate salts, if present, are then converted to sulfonic acid groups.

The cross linked ion conducting polymer resists swelling upon exposure to water, methanol or water methanol mixtures as compared to the same material which has not been cross linked or which has been cross linked using prior art protocols. As a consequence, the membrane has a lower water content and lower methanol cross over.

In some embodiments, all or a portion of the sulfonic acid or sulfonate salt groups of the precursor ion conducting polymer are converted to sulfonyl halide groups to form an activated ion conducting polymer.

In another embodiment, all or a portion of the sulfonic acid groups or sulfonate salt groups of the precursor ion conducting polymer are converted to sulfinate salt groups to form an activated ion conducting polymer. The activated polymer is then combined with a chemically reactive reagent or cross-linking agent other than a bifunctional crosslinking agent to form a reactive polymer mixture which is then formed into a membrane.

In yet another embodiment, all or a portion of the sulfonic acid groups or sulfonate salts of the precursor ion conducting polymer are converted to sulfonyl halide or sulfinate salt groups to form an activated polymer. The polymer is then combined with a bifunctional cross-linking agent comprising an ion conducting group, such as sulfonic acid or its sulfonate salt, and formed into a membrane.

In addition to the foregoing, two or more different ion conducting polymers can be used to form a heterogeneous cross-linked ionomer membrane.

In still another embodiment, all or a portion of the sulfonic acid or sulfonate groups of a first precursor ion conducting polymer are converted to sulfonyl halide to form a first activated ion conducting polymer while all or a portion of the sulfonic acid or sulfonate salts of a second precursor ion conducting polymer are converted to sulfinate salts to form a second activated ion conducting polymer. The first and second activated ion conducting polymers are then combined with a chemically reactive reagent to form a reactive polymer mixture which is then used to form a membrane. The first and second precursor ion conducting polymers used to form the first and second activated polymers can be the same or different.

In other embodiments, a semi-interpenetrating polymer network can be produced by use of a second ion conducting copolymer in which the sulfonic acid groups have not been converted to sulfonyl halide or sulfinate salt. In this situation, the sulfonic acid groups do not participate in the cross linking reactions and the second ion conducting polymer becomes entrapped by the cross linked network. It is to be understood that this “second’ ion conducting polymer may be the same as the ion conducing polymer used to form the cross linked membrane except the sulfonate groups are not modified so as to participate in the cross linking reaction. A depiction of such a network is shown in FIG. 3.

The cross-linked PEMs can be used to make catalyst coated proton exchange membranes (CCM's) and membrane electrode assemblies (MEA's) that are useful in fuel cells such as hydrogen and direct methanol fuel cells. Such fuel cells can be used in electronic devices, both portable and fixed, power supplies including auxiliary power units (APU's) and for locomotive power for vehicles such as automobiles, aircraft and marine vessels and APU's associated therewith.

### BRIEF DESCRIPTION OF THE DRAWINGS

FIG. 1 depicts the formation of a cross linked ion conducting polymer. Sulfonate groups on the precursor polymer are converted to sulfonyl chloride or sodium sulfinate groups. Each of the activated polymers separately reacts with a crosslinker to form the cross linked ion conducting polymer.

FIG. 2 depicts a bifunctional crosslinking agent that also contains a sulfonate group that can be used as an ion conducting moiety when the crosslinker is incorporated into the cross linked ion conducting polymer network.

FIG. 3 depicts a semi-interpenetrating crosslinked ion conducting polymer network.

FIG. 4 depicts a thiosulfonate linkage between two ion conductive polymers formed by a reaction between two sulfonyl chloride groups.

FIG. 5 depicts a thiosulfonate linkage between two ion conductive polymers formed by a reaction between two sodium sulfinate groups.

FIG. 6 depicts an alkyl disulfone bridge between two ion conductive polymers formed by a reaction of two sodium sulfinate groups with an difunctional alkyl dihalide.

FIG. 7 is a graph showing the effect of crosslinking on the amount of material leached from a membrane as a function of IECv

### DETAILED DESCRIPTION OF THE INVENTION

Precursor ion conducting polymers and/or copolymers are used in the formation of activated ion conducting polymers or copolymers. The precursor ion conducting polymers or copolymers contain sulfonate groups that are converted to sulfonyl halides and/or sulfinic salts that can react with each other in the presence of an appropriate chemically reactive regent or with a bifunctional cross linking agent to form a cross linked ion conducting polymer.

### Precursor Ion Conducting Polymers

Preferred precursor ion-conductive copolymers having sulfonate groups (SO₃M) that can be converted to activated copolymers containing sulfonyl halide or sulfinate salts for cross linking can be represented by Formula I:

[[—((Ar₁-T)ₜ-Ar₁—Z—(Ar₂—U)ᵤ—Ar₂—Z—)ᵢ]ₐ^{m}/(—(Ar₃—V)ᵥ—Ar₃—Z—)_{b}ⁿ/[[—((Ar₄—W)_{w}—Ar₄—Z—(Ar₅—X)ₓ—Ar₅—Z—)ⱼ]_{c}^{o}/(—(Ar₆—Y)_{y}—Ar₆—Z—)_{d}^{p}/] Formula I
wherein Ar₁, Ar₂, Ar₃, Ar₄ Ar₅, and Ar₆ are aromatic moieties;
at least one of Ar₁ and at least one of Ar₃ comprises a sulfonate group —SO₃M,
where M is H or alkali metal cation;
T, U, V W, X and Y are linking moieties;
Z is independently —O— or —S—;
i and j are independently integers greater than 1;
t, u, v, w, x, and y are independently 0 or 1
a, b, c, and d are mole fractions wherein the sum of a, b, c and d is 1, at least one of a and b is greater than 0 and at least one of c and d is greater than 0; and
m, n, o, and p are integers indicating the number of different oligomers or monomers in the copolymer.

The precursor ion conducting copolymer may also be represented by Formula II:

[[—((Ar₁-T)ₜ-Ar₁—Z—(Ar₂—U)ᵤ—Ar₂—Z—)ᵢ]ₐ^{m}/(—(Ar₃—V)ᵥ—Ar₃—Z—)_{b}ⁿ/[—((Ar₄—W)_{w}—Ar₄—Z—(Ar₅—X)ₓ—Ar₅—Z—)ⱼ]_{c}^{o}/(—(Ar₆—Y)_{y}—Ar₆—Z—)_{d}^{p}/] Formula II
wherein Ar₁, Ar₂, Ar₃, Ar₄, Ar₅, and Ar₆ are independently phenyl, substituted phenyl, napthyl, terphenyl, aryl nitrile and substituted aryl nitrile; at least one of Ar₁ and at least one of Ar₃ comprises a sulfonate group groups-SO₃M, where M is H or alkali metal cation;
T, U, V W, X and Y are independently a bond, —C(O)—,

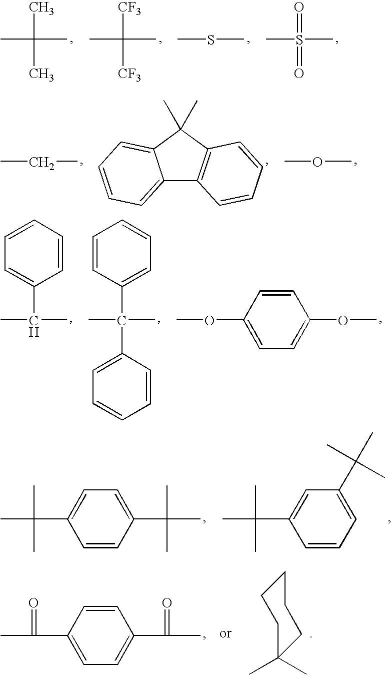

Z is independently —O— or —S—;
i and j are independently integers greater than 1;
t, u, v, w, x, and y are independently 0 or 1
a, b, c, and d are mole fractions wherein the sum of a, b, c and d is 1, at least
one of a and b is greater than 0 and at least one of c and d is greater than 0; and
m, n, o, and p are integers indicating the number of different oligomers or monomers in the copolymer.

The precursor ion-conductive copolymer can also be represented by Formula III:

[[—((Ar₁-T)ₜ-Ar₁—Z—(Ar₂—U)ᵤ—Ar₂—Z—)ᵢ]ₐ^{m}/(—(Ar₃—V)ᵥ—Ar₃—Z—)_{b}ⁿ/[—((Ar₄—W)_{w}—Ar₄—Z—(Ar₅—X)ₓ—Ar₅—Z—)ⱼ]_{c}^{o}/(—(Ar₆—Y)_{y}—Ar₆—Z—)_{d}^{p}/] Formula III
wherein Ar₁, Ar₂, Ar₃, Ar₄, Ar₅, and Ar₆ are independently phenyl, substituted phenyl, napthyl, terphenyl, aryl nitrile and substituted aryl nitrile;
at least one of Ar₁ and at least one of Ar₃ comprises a sulfonate group groups —SO₃M, where M is H or alkali metal cation;
T, U, V, W, X and Y are independently a bond O, S, C(O), S(O₂), alkyl, branched alkyl, fluoroalkyl, branched fluoroalkyl, cycloalkyl, aryl, substituted aryl or heterocycle;
Z is independently —O— or —S—;
i and j are independently integers greater than 1;
t, u, v, w, x, and y are independently 0 or 1
a, b, c, and d are mole fractions wherein the sum of a, b, c and d is 1, at least one of a and b is greater than 0 and at least one of c and d is greater than 0; and
m, n, o, and p are integers indicating the number of different oligomers or monomers in the copolymer.

In each of the foregoing formulas:
—((Ar₁-T)ₜ-Ar₁—Z—(Ar₂—U)ᵤ—Ar₂—Z—)ᵢ] is an ion conducting oligomer where one or more of Ar1 contains SO₃M;
(—(Ar₃—V)ᵥ—Ar₃—Z—) is an ion conducting comonomer where one or both of Ar3 contains SO₃M
—((Ar₄—W)_{w}—Ar₄—Z—(Ar₅—X)ₓ—Ar₅—Z—)ⱼ is a non ionic oligomer; and
(—(Ar₆—Y)_{y}—Ar₆—Z—) is a comonomer

In preferred embodiments, i and j are independently from 2 to 12, more preferably from 3 to 8 and most preferably from 4 to 6.

The mole fraction “a” of ion-conducting oligomer in the copolymer is between 0.1 and 0.9, preferably between 0.3 and 0.9, more preferably from 0.3 to 0.7 and most preferably from 0.3 to 0.5.

The mole fraction “b” of ion conducting monomer in the copolymer is preferably from 0 to 0.5, more preferably from 0.1 to 0.4 and most preferably from 0.1 to 0.3.

The mole fraction of “c” of non-ion conductive oligomer is preferably from 0 to 0.3, more preferably from 0.1 to 0.25 and most preferably from 0.01 to 0.15.

The mole fraction “d” of non-ion conducting monomer in the copolymer is preferably from 0 to 0.7, more preferably from 0.2 to 0.5 and most preferably from 0.2 to 0.4.

In some instance, b, c and d are all greater then zero. In other cases, a and c are greater than zero and b and d are zero. In other cases, a is zero, b is greater than zero and at least c or d or c and d are greater than zero. Nitrogen is generally not present in the copolymer backbone.

The indices m, n, o, and p are integers that take into account the use of different monomers and/or oligomers in the same copolymer or among a mixture of copolymers, where m is preferably 1, 2 or 3, n is preferably 1 or 2, o is preferably 1 or 2 and p is preferably 1, 2, 3 or 4.

In some embodiments, when there is no hydrophobic oligomer, i.e. when c is zero in Formulas I, II, or III: (1) the precursor ion conductive monomer used to make the ion-conducting polymer is not 2,2′ disulfonated 4,4′ dihydroxy biphenyl or (2) the ion conductive polymer does not contain the ion-conducting monomer that is formed using this precursor ion conductive monomer.

In preferred embodiments, the SO₃M group is covalently attached to an aromatic group. In addition, various linkers may be used to position the SO₃M group away from the ion conducting copolymer backbone. Such backbones are preferably aliphatic C₁-C₁₀.

A random ion conducting copolymer is set forth in Formula IV

[—Ar₁-T)ₜ-Ar₁—Z—(Ar₂—U)ᵤ—Ar₂—Z—)ᵢ]ₐ^{m}/[—((Ar₄—W)_{w}—Ar₄—Z—(Ar₅—X)ₓ—Ar₅—Z—)ⱼ]_{c}^{o}/ Formula IV
where the definitions for each of the components are set forth above, except that the sum of mole fractions a plus b equal 1 (where a is preferably from 0.2 to 0.5 and c is from 0.5 to 0.08) and i and j each equal 1.

The following are some of the monomers used to make precursor ion-conductive copolymers.

### 1) Precursor Difluoro-End Monomers

| | | Molecular | |
|---|---|---|---|
| Acronym | Full Name | weight | Chemical structure |
| Bis K | 4,4′-Difluorobenzophenone | 218.20 | 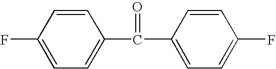 |
| Bis SO₂ | 4,4′-Difluorodiphenylsulfone | 254.25 | 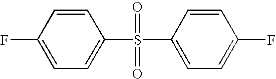 |
| S-Bis-K | 3,3′-disulfonated-4,4′-difluorobenzophone | 422.28 | 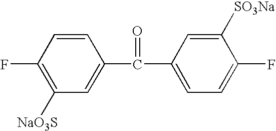 |

### 2) Precursor Dihydroxy-End Monomers

| | | | |
|---|---|---|---|
| Bis AF(AFor 6F) | 2,2-Bis(4-hydroxyphenyl)hexafluoropropane or4,4′-(hexafluoroisopropylidene)diphenol | 336.24 | 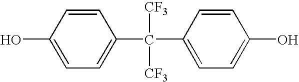 |
| BP | Biphenol | 186.21 | 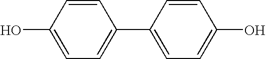 |
| Bis FL | 9,9-Bis(4-hydroxyphenyl)fluorene | 350.41 | 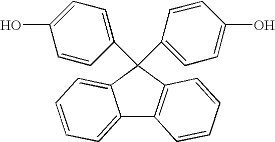 |
| Bis Z | 4,4′-cyclohexylidenebisphenol | 268.36 | 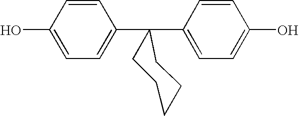 |
| Bis S | 4,4′-thiodiphenol | 218.27 | 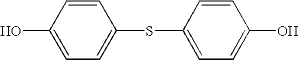 |

### 3) Precursor Dithiol-End Monomer

| | | Molecu- | |
|---|---|---|---|
| Acro- | Full | lar | |
| nym | Name | weight | Chemical Structure |
| | 4,4′-thiolbisbenzenethiol | | 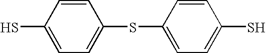 |

Examples of monomers containing R where R is SO₃M (where M is H or alkali metal cation) include but are not limited to:

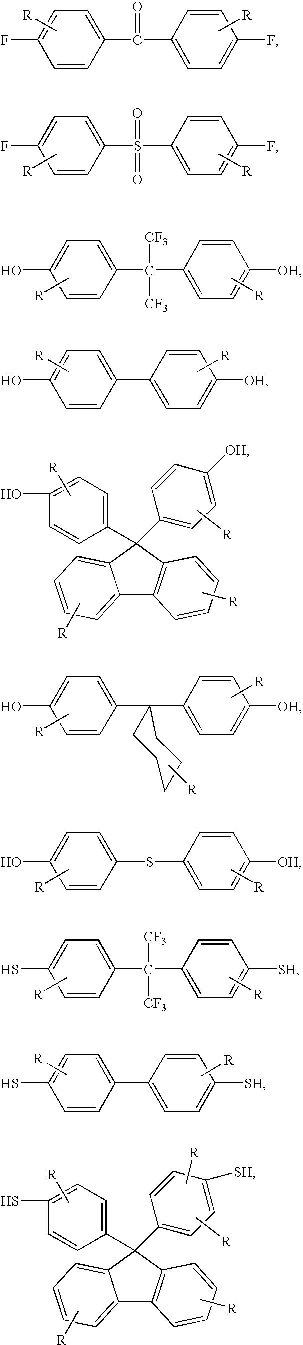

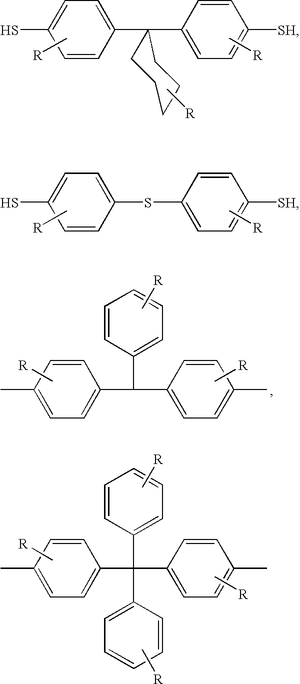

In some cases, it may be desirable to use a monovalent monomer to limit the length of the copolymer. Example of such monomers that are restricted to one and/or the other termini of the copolymer include but are not limited to:

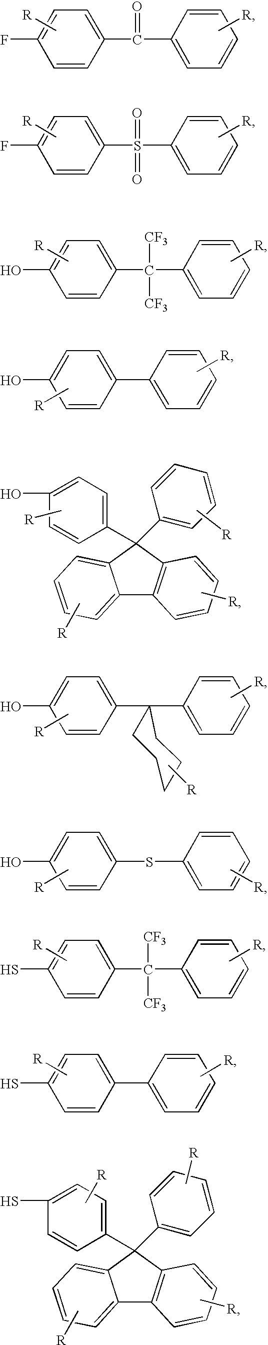

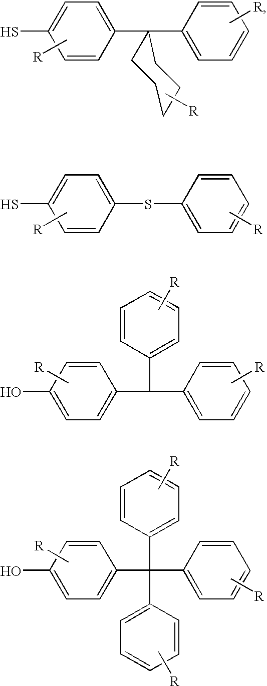

In the foregoing, it should be understood that OH can replace SH groups and vice versa.

Ion conducting copolymers and the monomers used to make them and which are not otherwise identified herein can also be used. Such ion conducting copolymers and monomers include those disclosed in U.S. patent application Ser. No. 09/872,770, filed Jun. 1, 2001, Publication No. US 2002-0127454 A1, published Sep. 12, 2002, entitled “Polymer Composition”; U.S. patent application Ser. No. 10/351,257, filed Jan. 23, 2003, Publication No. US 2003-0219640 A1, published Nov. 27, 2003, entitled “Acid Base Proton Conducting Polymer Blend Membrane”; U.S. patent application Ser. No. 10/438,186, filed May 13, 2003, Publication No. US 2004-0039148 A1, published Feb. 26, 2004, entitled “Sulfonated Copolymer”; U.S. patent application Ser. No. 10/438,299, filed May 13, 2003, entitled “Ion-conductive Block Copolymers,” published Jul. 1, 2004, Publication No. 2004-0126666; U.S. application Ser. No. 10/449,299, filed Feb. 20, 2003, Publication No. US 2003-0208038 A1, published Nov. 6, 2003, entitled “Ion-conductive Copolymer”; U.S. patent application Ser. No. 10/438,299, filed May 13, 2003, Publication No. US 2004-0126666; U.S. patent application Ser. No. 10/987,178, filed Nov. 12, 2004, entitled “Ion-conductive Random Copolymer”, Publication No. 2005-0181256 published Aug. 18, 2005; U.S. patent application Ser. No. 10/987,951, filed Nov. 12, 2004, Publication No. 2005-0234146, published Oct. 20, 2005, entitled “Ion-conductive Copolymers Containing First and Second Hydrophobic Oligomers;” U.S. patent application Ser. No. 10/988,187, filed Nov. 11, 2004, Publication No. 2005-0282919, published Dec. 22, 2005, entitled “Ion-conductive Copolymers Containing One or More Hydrophobic Oligomers”; and U.S. patent application Ser. No. 11/077,994, filed Mar. 11, 2005, Publication No. 2006-004110, published Feb. 23, 2006, each of which are expressly incorporated herein by reference. Other comonomers include those used to make sulfonated trifluorostyrenes (U.S. Pat. No. 5,773,480), acid-base polymers, (U.S. Pat. No. 6,300,381), poly arylene ether sulfones (U.S. Patent Publication No. US2002/0091225A1); graft polystyrene (Macromolecules 35:1348 (2002)); polyimides (U.S. Pat. No. 6,586,561 and J. Membr. Sci. 160:127 (1999)) and Japanese Patent Applications Nos. JP2003147076 and JP2003055457, each of which are expressly incorporated herein by reference.

The mole percent of ion-conducting groups when two ion-conducting group is present in a comonomer is preferably between 20 and 70%, or more preferably between 25 and 60%, and most preferably between 30 and 50%. When more than one conducting group is contained within the ion-conducting monomer, such percentages are multiplied by the total number of ion-conducting groups per monomer. Thus, in the case of a monomer comprising two sulfonic acid groups, the preferred sulfonation is 40 to 140%, more preferably 50 to 120% and most preferably 60 to 100%. Alternatively, the amount of ion-conducting group can be measured by the ion exchange capacity (IEC). By way of comparison, Nafion® typically has a ion exchange capacity of 0.9 meq per gram. In the present invention, it is preferred that the IEC be between 0.7 and 3.0 meq per gram, more preferably between 0.8 and 2.5 meq per gram, and most preferably between 1.0 and 2.0 meq per gram.

Although the copolymers of the invention have been described in connection with the use of arylene polymers, in principle the ionic and non-ionic monomers used to make the ion condcuting copolymers need not be arylene but rather may be aliphatic or perfluorinated aliphatic backbones containing SO₃M groups. SO₃M groups may be attached to the backbone or may be pendant to the backbone, e.g., attached to the polymer backbone via a linker. Alternatively, SO₃M can be formed as part of the standard backbone of the polymer. See, e.g., U.S. 2002/018737781, published Dec. 12, 2002 incorporated herein by reference. Any of these ion-conducting oligomers can be used to practice the present invention.

### Formation of Activated Ion Conducting Polymers

PEM's may be fabricated by solution casting of the activated ion-conductive copolymer in conjunction with heat or radiation to induce cross-linking among the copolymers in the PEM. The only condition required to start the cross linking is that the activated polymer and the chemically active reagent and/or the crosslinking agent be dissolved in a common solvent. The membrane is then dried, treated with dilute base, dilute acid and then washed thoroughly with water to form a chemically crosslinked proton exchange membrane. The resultant cross-linked polymer is depicted in FIG. 1.

The mechanism and chemical bonds formed as the result of the crosslinking reactions are unclear. While not being bound by the following, it is thought that one or both of two mechanisms may be taking place:

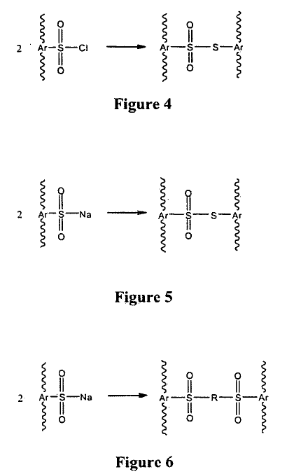

In the case of the reaction of the sulfonyl halide (SO₂X)-functionalized crosslinkable polymers with the crosslinking agents it is thought that the crosslink that forms is a thiosulfonate linkage (SO₂—S). See FIG. 4.

In the case of the reaction of the sulfinate (SO2M)-functionalized crosslinkable polymers with the monofunctional alkyl halide or alkali metal halide crosslinking agent, it is also thought that the crosslink that forms is a thiosulfonate linkage. See FIG. 5.

The chemically active reagent can be an alkali metal bromide (MBr) or iodide (MI) such as potassium iodide (KI). It can also be a monofunctional alkyl halide (RX) where X is halide and R is linear or branched C₁-C₆. An example is 1-iodopropane. These reagents are consumed during the cross linking reaction.

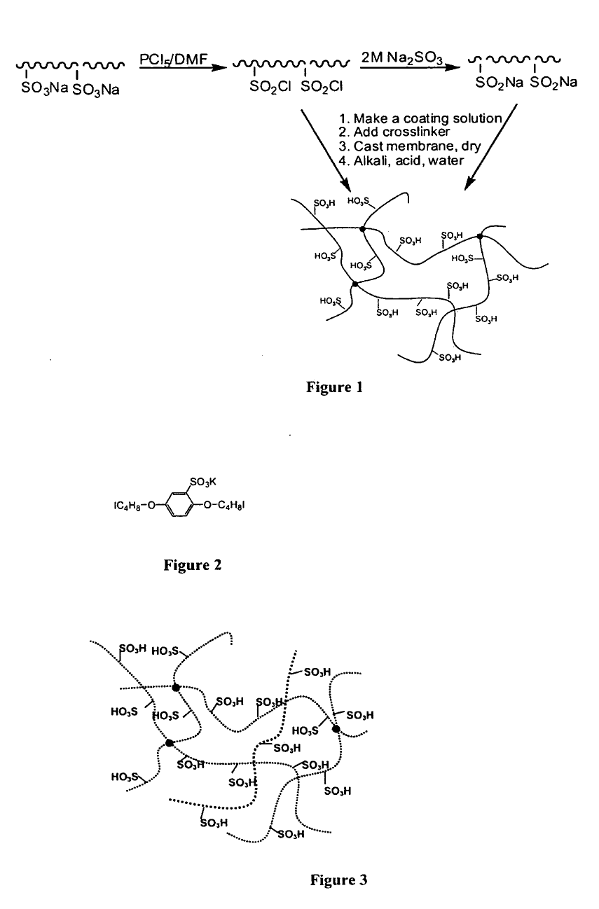

Crosslinking agents include difunctional alkyl halide (XRX) where X is halide and R is linear or branched C₁-C₆. Examples include 1,4-diiodobutane and 1,6-dibromohexane. Difunctional alkyl halide can react with sulfonly halides and/or sulfinate salts to form an intra-polymer or inter-polymer covalent bridge. In the case of difunctional crosslinking agents, the crosslinking agent may also contain sulfonate or aromatic sulfonate moieties that end up incorporated into the covalent bridge. See FIG. 2. However, difunctional alkyl halides can also act as a chemically active reagent which is consumed in the reaction but not incorporated into the croos linked polymer. In such instances, the crosslinked polymer network can contain alkyl disulfone bridges (FIG. 6) and thiosulfonate linkages (FIGS. 4 and 5).

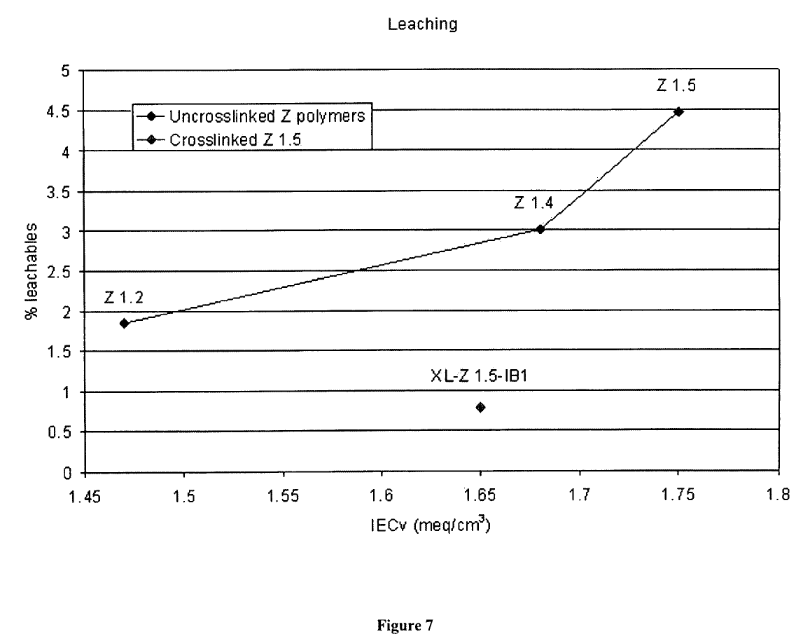

FIG. 7 depicts the results of a leaching vs. IEC test comparing one crosslinked membrane against membranes that are not cross-linked. Polymer membranes were soaked in 12M MeOH at 80 C for 7 days and the amount of leachable organic material was measured. For the non-crosslinked membranes, the amount of leachable material is related to the IEC of the material. With a crosslinked material, the amount of leachable material was much lower even at higher IEC. This demonstrates an important property of the crosslinked materials—they are more stable in high concentrations of methanol. Furthermore, they are insoluble in other organic solvents such as DMAc and NMP.

### PEMs, CCMs, MEAs and Fuel Cells

When cast into a membrane and cross-linked, the PEM can be used in a fuel cell. It is preferred that the membrane thickness be between 0.1 to 10 mils, more preferably between 1 and 6 mils, most preferably between 1.5 and 2.5 mils.

As used herein, a membrane is permeable to protons if the proton flux is greater than approximately 0.005 S/cm, more preferably greater than 0.01 S/cm, most preferably greater than 0.02 S/cm.

As used herein, a membrane is substantially impermeable to methanol if the methanol transport across a membrane having a given thickness is less than the transfer of methanol across a Nafion membrane of the same thickness. In preferred embodiments the permeability of methanol is preferably 50% less than that of a Nafion membrane, more preferably 75% less and most preferably greater than 80% less as compared to the Nafion membrane.

The cross linked PEM may be used to produce a catalyst coated membrane (CCM). As used herein, a CCM comprises a crosslinked PEM when at least one side and preferably both of the opposing sides of the PEM are partially or completely coated with catalyst. The catalyst is preferable a layer made of catalyst and ionomer. Preferred catalysts are Pt and Pt—Ru. Preferred ionomers include Nafion and other ion-conductive polymers. In general, anode and cathode catalysts are applied onto the membrane using well established standard techniques. For direct methanol fuel cells, platinum/ruthenium catalyst is typically used on the anode side while platinum catalyst is applied on the cathode side. For hydrogen/air or hydrogen/oxygen fuel cells platinum or platinum/ruthenium is generally applied on the anode side, and platinum is applied on the cathode side. Catalysts may be optionally supported on carbon. The catalyst is initially dispersed in a small amount of water (about 100 mg of catalyst in 1 g of water). To this dispersion a 5% ionomer solution in water/alcohol is added (0.25-0.75 g). The resulting dispersion may be directly painted onto the polymer membrane. Alternatively, isopropanol (1-3 g) is added and the dispersion is directly sprayed onto the membrane. The catalyst may also be applied onto the membrane by decal transfer, as described in the open literature (Electrochimica Acta, 40: 297 (1995)).

The CCM is used to make MEA's. As used herein, an MEA refers to an ion-conducting polymer membrane made from a CCM according to the invention in combination with anode and cathode electrodes positioned to be in electrical contact with the catalyst layer of the CCM.

The electrodes are in electrical contact with the catalyst layer, either directly or indirectly via a gas diffusion or other conductive layer, so that they are capable of completing an electrical circuit which includes the CCM and a load to which the fuel cell current is supplied. More particularly, a first catalyst is electrocatalytically associated with the anode side of the PEM so as to facilitate the oxidation of hydrogen or organic fuel. Such oxidation generally results in the formation of protons, electrons and, in the case of organic fuels, carbon dioxide and water. Since the membrane is substantially impermeable to molecular hydrogen and organic fuels such as methanol, as well as carbon dioxide, such components remain on the anodic side of the membrane. Electrons formed from the electrocatalytic reaction are transmitted from the anode to the load and then to the cathode. Balancing this direct electron current is the transfer of an equivalent number of protons across the membrane to the cathodic compartment. There an electrocatalytic reduction of oxygen in the presence of the transmitted protons occurs to form water. In one embodiment, air is the source of oxygen. In another embodiment, oxygen-enriched air or oxygen is used.

The membrane electrode assembly is generally used to divide a fuel cell into anodic and cathodic compartments. In such fuel cell systems, a fuel such as hydrogen gas or an organic fuel such as methanol is added to the anodic compartment while an oxidant such as oxygen or ambient air is allowed to enter the cathodic compartment. Depending upon the particular use of a fuel cell, a number of cells can be combined to achieve appropriate voltage and power output.

CCMs and MEAs are generally useful in fuel cells such as those disclosed in U.S. Pat. Nos. 5,945,231, 5,773,162, 5,992,008, 5,723,229, 6,057,051, 5,976,725, 5,789,093, 4,612,261, 4,407,905, 4,629,664, 4,562,123, 4,789,917, 4,446,210, 4,390,603, 6,110,613, 6,020,083, 5,480,735, 4,851,377, 4,420,544, 5,759,712, 5,807,412, 5,670,266, 5,916,699, 5,693,434, 5,688,613, 5,688,614, each of which is expressly incorporated herein by reference.

The CCMs and MEAs of the invention may also be used in hydrogen fuel cells that are known in the art. Examples include 6,630,259; 6,617,066; 6,602,920; 6,602,627; 6,568,633; 6,544,679; 6,536,551; 6,506,510; 6,497,974, 6,321,145; 6,195,999; 5,984,235; 5,759,712; 5,509,942; and 5,458,989 each of which are expressly incorporated herein by reference.

### Applications

The fuel cells can be used in many applications including electrical power sources for residential, industrial, commercial power systems and for use in locomotive power such as in automobiles. Other uses to which the invention finds particular use includes the use of fuel cells in portable electronic devices such as cell phones and other telecommunication devices, video and audio consumer electronics equipment, computer laptops, computer notebooks, personal digital assistants and other computing devices, GPS devices and the like. In addition, the fuel cells may be stacked to increase voltage and current capacity for use in high power applications such as industrial and residential sewer services or used to provide locomotion to vehicles. Such fuel cell structures include those disclosed in U.S. Pat. Nos. 6,416,895, 6,413,664, 6,106,964, 5,840,438, 5,773,160, 5,750,281, 5,547,776, 5,527,363, 5,521,018, 5,514,487, 5,482,680, 5,432,021, 5,382,478, 5,300,370, 5,252,410 and 5,230,966.

### EXAMPLES

### Preparation of a sulfonyl chloride (SO₂Cl)-Functionalized Crosslinkable Polymers

### Example 1

A poly(arylcne ether ketone) functionalized with sodium sulfonate (SO₃Na) groups (See Formula V) and an ion-exchange capacity of 1.5 meq/g was dried at 100 C under vacuum. The polymer (25.0 g) was dissolved in 976.2 grams of N,N-dimethyl formamide under nitrogen. After the polymer was completely dissolved, 314 g of toluene were added and azeotropically removed at 140 C. The polymer solution was cooled to room temperature at which point PCl₅ (19.5 g) (representing a molar ratio of 2.5 PCl₅ for each SO₃Na group) were added. The mixture was stirred at 50 C for 16 hours after which it was cooled and precipitated into 2.51 isopropanol. The polymer precipitated as a white powder, was recovered by vacuum filtration, and was washed thoroughly 5 times with deionized water. The polymer was recovered by vacuum filtration and dried in an oven at 80 C.

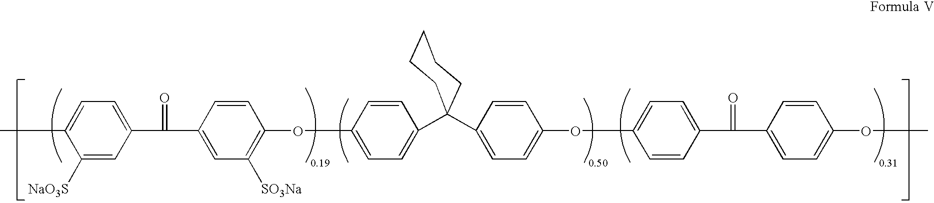

### Example 2

A sulfonyl chloride (SO₂Cl)-functionalized polymer was produced as in Example 1 except that the starting sodium sulfonate (SO₃Na)-functionalized polymer had an ion-exchange capacity 1.9 meq/g.

### Preparation of a sodium sulfinate (SO₂Na)-Functionalized Crosslinkable Polymers

### Example 3

10.0 grams of the sulfonyl chloride (SO₂Cl)-functionalized polymer fabricated in Example 1 were dried at 100 C. under vacuum. The dried polymer was placed in a 500 mL 3-neck round bottom flask with 200 ml of 2M Na₂SO₃ and stirred at 70 C for 24 hours. The polymer was recovered by vacuum filtration and washed several times with deionized water. The polymer was recovered and dried in an oven at 80 C.

### Example 4

A sodium sulfinate (SO₂Na)-functionalized polymer was fabricated according to Example 3 except that the starting sulfonyl chloride (SO₂Cl)-functionalized polymer used was the one produced in Example 2.

### Preparation of Compositions of Chemically Crosslinked Ionomer Membranes

### Example 5

The SO₂Na functionalized polymer (13.9 g) fabricated as in Example 3 was dissolved in N-methyl pyrrolidone (NMP) (41.7 g). To the solution was added 7.1 g of the cross linking agent 1,4-diiodobutane, representing 0.5 eq of iodo-functionalities for every eq. of sulfonate functionality on the original polymer. The mixture was cast into a membrane via web-assisted knife-coating, dried to remove solvent, treated with 0.5M NaOH for 24 hours, 1 M H2SO4 for 24 hours and washed thoroughly, resulting in a crosslinked proton exchange membrane.

### Example 6

A crosslinked membrane was fabricated as in Example 5 except the SO₂Na-functionalized polymer used was the one produced as in Example 4.

### Example 7

A crosslinked membrane was fabricated as in Example 5, except the chemically active reagent used was 1-iodopropane.

### Example 8

A crosslinked membrane was fabricated as in Example 5, except the chemically active reagent used was a 5% solution of potassium iodide in NMP.

### Example 9

A crosslinked membrane was fabricated as in Example 5, except the crosslinkable polymer was the SO2Cl-functionalized polymer produced in Example 1.

### Example 10

A crosslinked membrane was fabricated as in Example 9, except the chemically active reagent used was 1-iodopropane.

### Example 11

A crosslinked membrane was fabricated as in Example 9, except the chemically active reagent used was a 5% solution of potassium iodide in NMP.

### Example 12

A crosslinked membrane was fabricated as in Example 5, except the crosslinking agent used was a 26% solution of the sulfonate functionalized crosslinking agent in FIG. 2 in DMSO.

### Example 13

A semi-interpenetrating polymer network proton exchange membrane was prepared as in example 5, except that in addition to the sodium sulfinate (SO₂Na)-functionalized crosslinkable precursor polymer an equal amount of non-crosslinkable sodium sulfonate (SO₃Na)-functionalized polymer was added with an ion-exchange capacity of 1.9 meq/g (FIG. 3).

What is claimed is:

1. A method for making a cross-linked ionomer membrane comprising:
(a) converting all or a portion of the sulfonic acid or sulfonate salt groups of at least one ion conducting polymer to sulfonyl halide or sulfinate salt groups to form activated polymer;
(b) contacting said activated polymer with at least one of a chemically active reagent and a cross-linking agent to form a reactive polymer mixture; and
(c) forming a membrane with said reactive polymer mixture under conditions that permit crosslinking of said activated polymer.

2. A method for making a cross-linked ionomer membrane comprising:
(a) converting all or a portion of the sulfonic acid groups or sulfonate salts of at least one ion conducting polymer to sulfonyl halide or sulfinate salt groups to form activated polymer;
(b) contacting said activated polymer with a bifunctional cross-linking agent comprising an ion conducting group to form a reactive polymer mixture; and
(c) forming a membrane with said reactive polymer mixture under conditions that permit cross linking of said reactive polymer.

3. A method for making a cross-linked ionomer membrane comprising:
(a) converting all or a portion of the sulfonic acid groups or sulfonate salt groups of a first ion conducting polymer to sulfinate salt groups to form first activated polymer;
(b) converting all or a portion of the sulfonic acid groups or sulfonate salt groups of a second ion conducting polymer to sulfonyl halide groups to form a second activated polymer;
(c) combining said first and said second activated ion conducting polymers to form a reactive polymer mixture; and
(d) forming a membrane with said reactive polymer mixture under conditions that permit cross linking of said reactive polymer.

4. The method according to any of claims 1-2 wherein said ion conducting polymer comprises two or more different ion conducting polymers.

5. The method of any of claims 1 through 4 further comprising converting residual sulfonyl halide or sulfinate salt groups to sulfonic acid groups.

6. The method of any of claims 1 through 4 wherein said two sulfonyl halide groups, two sulfinate salt groups or a sulfonyl halide and sulfinate salt react with each other to form a direct linkage between said reactive polymers.

7. The method of claim 6 wherein said direct linkage comprises a thiosulfonate linkage.

8. The method of claim 1, 2 or 3 further comprising forming said membrane in the presence of a different ion conducting polymer comprising SO₃M, where M is H or alkali metal cation to form a semi-interpentrating polymer network

9. A polymer electrolyte membrane (PEM) made according to any of the methods of claim 1-8.

10. A polymer electrolyte membrane comprising cross linked ion conducting copolymer, where the members of at least a portion of said a crosslinked ion conducting copolymers have the formula
[[—((Ar₁-T)ₜ-Ar₁—Z—(Ar₂—U)ᵤ—Ar₂—Z—)ᵢ]ₐ^{m}/(—(Ar₃—V)ᵥ—Ar₃—Z—)_{b}ⁿ/[—((Ar₄—W)_{w}—Ar₄—Z—(Ar₅—X)ₓ—Ar₅—Z—)_{c}^{o}/(—(Ar₆—Y)_{y}—Ar₆—Z—)_{d}^{p}/]
wherein Ar₁, Ar₂, Ar₃, Ar₄, Ar₅, and Ar₆ are aromatic moieties;
at least one of Ar₁ and at least one of Ar₃ comprises a sulfonate group groups —SO₃M, where M is H or alkali metal cation;
wherein at least one of Ar₁ and at least one of Ar₃ on the same or different copolymers are covalently attached to each other by a thiosulfonate or alkyl disulfone bridge;
T, U, V W, X and Y are linking moieties;
Z is independently —O— or —S—;
i and j are independently integers greater than 1;
t, u, v, w, x, and y are independently 0 or 1
a, b, c, and d are mole fractions wherein the sum of a, b, c and d is 1, at least one of a and b is greater than 0 and at least one of c and d is greater than 0; and
m, n, o, and p are integers indicating the number of different oligomers or monomers in the copolymer.

11. A catalyst coated membrane (CCM) comprising the PEM of claim 9 or 10 wherein all or part of at least one opposing surface of said PEM comprises a catalyst layer.

12. A membrane electrode assembly (MEA) comprising the CCM of claim 11.

13. A fuel cell comprising the PEM of claim 9 or 10.

14. The fuel cell of claim 13 comprising a hydrogen fuel cell.

15. An electronic device comprising the fuel cell of claim 13.

16. A power supply comprising the fuel cell of claim 13.

17. An electric motor comprising the fuel cell of claim 13.

18. A vehicle comprising the electric motor of claim 17.
